(19) United States
(12) Patent Application Publication
(10) Pub. No.: US 2023/0056816 A1
(43) Pub. Date: Feb. 23, 2023

(54) SPARK PLUG

(71) Applicant: DENSO CORPORATION, Kariya-city (JP)

(72) Inventor: Ryohei AKIYOSHI, Kariya-city (JP)

(21) Appl. No.: 17/890,546

(22) Filed: Aug. 18, 2022

(30) Foreign Application Priority Data
Aug. 20, 2021 (JP) 2021-134661

(51) Int. Cl. H01T 13/39

(52) U.S. Cl. CPC H01T 13/39

(57) ABSTRACT

A spark plug includes a first discharge chip and a second discharge chip which faces the first discharge chip and works to produce an electrical spark therebetween. At least one of the first and second discharge chips is made from material containing iridium, platinum, and tantalum. An amount of platinum in the material is in a range of 5 Wt % to 30 Wt %. An amount of tantalum is in a range of 0.3 Wt % to 7.5 Wt %. Use of such material enhances a wear resistance of the spark plug.

### CROSS REFERENCE TO RELATED DOCUMENT

The present application claims the benefit of priority of Japanese Patent Application No. 2021-134661 filed on Aug. 20, 2021, the disclosure of which is incorporated in its entirety herein by reference.

### BACKGROUND

### 1 Technical Field

This disclosure relates generally to a spark plug.

### 2 Background Art

Internal combustion engines for vehicles usually have a spark plug to ignite fuel in the engine. The spark plug is equipped with a center electrode and a ground electrode and generates an electric spark between the center and ground electrodes to ignite the fuel.

The center electrode and the ground electrode usually have areas where a sequence of electrical sparks is produced and which experience mechanical wear arising from the sparks. Japanese patent first publication No. 1997-298083 discloses a spark plug equipped with a center electrode and a ground electrode one or both of which are made from iridium material containing platinum to minimize the above-described wear of the spark plug. Japanese patent first publication No. 1997-298083 also teaches discharge chips which are made from platinum-containing iridium material and joined to one or both of the center and ground electrodes.

In recent years, high-current or high-voltage spark plugs have been used in order to increase output power from internal combustion engines or improve fuel economy of the engines. It is, therefore, necessary for spark plugs to have an enhanced wear resistance.

### SUMMARY

It is an object of this disclosure to provide a spark plug having an enhanced wear resistance.

According to one aspect of the disclosure, there is provided a spark plug which comprises: (a) a first discharge portion; and (b) a second discharge portion which faces the first discharge portion and works to produce a spark between itself and the first discharge portion. At least one of the first discharge portion and the second discharge portion is made from material containing iridium, platinum, and tantalum. An amount of platinum contained in the material lies in a range of 5 Wt % to 30 Wt %. An amount of tantalum contained in the material lies in a range of 0.3 Wt % to 7.5 Wt %.

The spark plug is, as described above, designed to have the first discharge portion and the second discharge portion at least one of which is made from material in which the amounts of platinum and tantalum are selected to lie in the above ranges, thereby decreasing the physical wear of the at least one of the first and second discharge portions. The first discharge portion and the second discharge portion may be implemented by a center electrode and a ground electrode of the spark plug themselves or alternatively, discharge chips joined to the center electrode and the ground electrode. In any case, the first and second discharge portions of the spark plug, as referred to in this disclosure, are constructed by portions of the spark plug which face each other through a spark gap.

The above structure enhances the wear resistance of the spark plug.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partial longitudinal sectional view which illustrates a spark plug according to the first embodiment;

FIG. 2 is a graph which represents relations between components of materials of discharge chips of test specimens of the spark plug in FIG. 1 and wear ratios of the discharge chips;

FIG. 3 is a graph which represents relations between components of first materials of discharge chips of test specimens of a spark plug in the second embodiment and wear ratios of the discharge chips;

FIG. 4 is a graph which represents relations between components of second materials of discharge chips of test specimens of a spark plug in the second embodiment and wear ratios of the discharge chips;

FIG. 5 is a graph which represents relations between components of third materials of discharge chips of test specimens of a spark plug in the second embodiment and wear ratios of the discharge chips;

FIG. 6 is a graph which represents relations between components of first materials of discharge chips of test specimens of a spark plug in the third embodiment and wear ratios of the discharge chips;

FIG. 7 is a graph which represents relations between components of second materials of discharge chips of test specimens of a spark plug in the third embodiment and wear ratios of the discharge chips; and

FIG. 8 is a graph which represents relations between components of third materials of discharge chips of test specimens of a spark plug in the third embodiment and wear ratios of the discharge chips.

### DESCRIPTION OF THE PREFERRED EMBODIMENTS

Embodiments will be described below with reference to the drawings. For the sake of simplicity of disclosure, the same or similar reference numbers will refer to the same or similar parts throughout the several views, and explanation thereof in detail will be omitted once it is made.

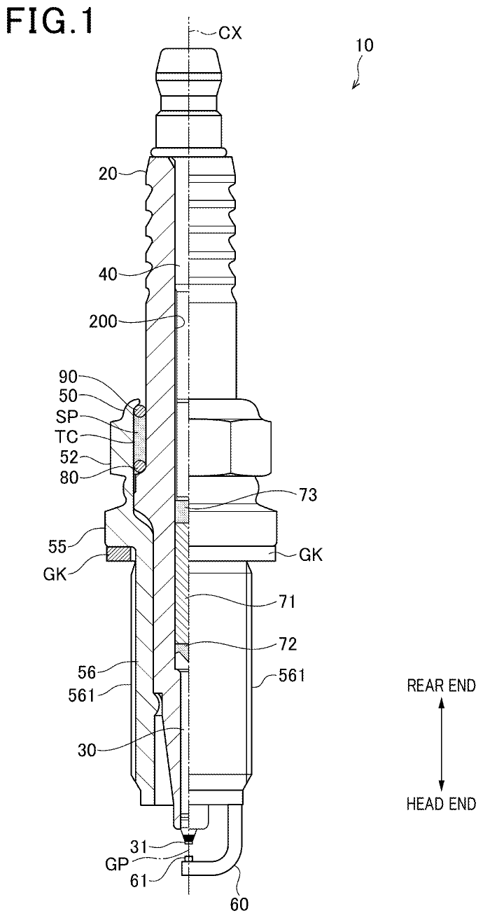

The structure of the spark plug 10 according to the first embodiment will first be described with reference to FIG. 1. FIG. 1 illustrates a longitudinal sectional view of the spark plug 10, as cut along the center axis CX, on the left side of the drawing, but shows the external appearances of the center electrode 30 and the metal terminal 40 as they are on the left side of the drawing. The center axis CX will be described later in detail.

The spark plug 10 is mounted in each cylinder of an internal combustion engine, not shown, in use and works to ignite fuel in a combustion chamber in the cylinder. The spark plug 10 includes the porcelain insulator 20, the center electrode 30, the metal terminal 40, the metal shell 50, and the ground electrode 60.

The porcelain insulator 20 is of a hollow cylindrical shape and made from insulating material, such as alumina. The porcelain insulator 20 has formed therein the axial hole 200 which extends through the center axis of the porcelain insulator 20. The axial hole 200 has the center axis coinciding with that of the porcelain insulator 20. The center axis (i.e., a longitudinal center line) of the axial hole 200 will also be referred to as the center axis CX. The axial hole 200 is shaped to have a circular transverse section, as viewed in a cross section of the porcelain insulator 20 taken perpendicular to the center axis CX.

The axial hole 200 has a given length with a first end portion (i.e., a lower end portion, as viewed in the drawing) and a second end portion (i.e., an upper end portion, as viewed in the drawing). The first end portion will also be referred to as a head end portion or a head end side, while the second end portion will also be referred to as a rear end portion or a rear end side. The center electrode 30 is made of a metallic material and retained by the porcelain insulator 20 in the first end portion (i.e., the head end portion) of the axial hole 200. The center electrode 30 is of a bar-shape and mostly disposed inside the axial hole 200. The center electrode 30 has a head end portion which protrudes from the axial hole 200 outside the porcelain insulator 20 and has the discharge chip 31 secured to the tip thereof.

The metal terminal 40 is made of metallic material and arranged in the second end portion (i.e., the rear end portion) of the axial hole 200. The metal terminal 40 extends along the center axis CX and is retained by the porcelain insulator 20. The metal terminal 40 is of a bar-shape and mostly disposed inside the axial hole 200. The metal terminal 40 has a portion which protrudes from the axial hole 200 outside the porcelain insulator 20 and functions as an electrode terminal to which voltage is applied from an external power supply, not shown.

The porcelain insulator 20 has a portion in which the center electrode 30 extends along the center axis CX and which will also be referred to below as a head end portion or a head end side. The porcelain insulator 20 has also a portion in which the metal terminal 40 extends along the center axis CX and which will also be referred to as a rear end portion or a rear end side.

The axial hole 200 has the resistor 71 disposed therein between the metal terminal 40 and the center electrode 30. The resistor 71 is an electrical component working to control or adjust an electrical resistance of an electrical circuit extending from the metal terminal 40 to the center electrode 30. The resistor 71 is made from material of glass and zirconia powder with a selected amount of additive of carbon powder. The degree of electrical resistance implemented by the resistor 71 is determined by the added amount of carbon powder. The resistor 71 arranged in the electrical circuit between the metal terminal 40 and the center electrode 30 serves to minimize electromagnetic noises arising from spark discharge from the spark plug 10. The resistor 71 and the center electrode 30 are electrically connected together through the conductive sealing layer 72. Similarly, the metal terminal 40 and the resistor 71 are electrically connected together through the conductive sealing layer 73. Each of the conductive sealing layers 72 and 73 is made from glass powder with an additive of copper powder in the form of a conductive layer.

The metal shell 50 is of a hollow cylindrical shape and surrounds a portion of the porcelain insulator 20 from outside. The whole of the metal shell 50 is made from metallic material. The metal shell 50 is mechanically crimped to make a firm joint to the porcelain insulator 20, so that the metal shell 50 firmly retains the porcelain insulator 20. The metal shell 50 includes the gripping portion 52, the flange 55, and the insertion portion 56.

The gripping portion 52 is used to provide a mechanical grip to a tool, such as a plug wrench, to attach the spark plug 10 to the internal combustion engine. The gripping portion 52 is of, for example, a hexagonal shape, as viewed along the center axis CX.

The flange 55 is arranged in contact with the outer surface of the internal combustion engine through the gasket GK when the spark plug 10 is mounted in the internal combustion engine. The flange 55 is located closer to the head of the spark plug 10 (i.e., the metal shell 50) than the gripping portion 52 is and protrudes radially outward.

The insertion portion 56 is a portion of the metal shell 50 which is located closer to the head of the spark plug 10 than the flange 55 is and inserted into a hole, not shown, formed in the internal combustion engine. The insertion portion 56 has the male thread 561 formed on an outer periphery thereof and is rotated around the center axis CX by mechanical pressure exerted by a tool on the gripping portion 52 when the spark plug 10 is mounted in the internal combustion engine. This achieves mechanical engagement between a female thread formed in the hole of the internal combustion engine and the male thread of the insertion portion 56, thereby tightly fastening the spark plug 10 to the internal combustion engine. After the spark plug 10 is installed in the internal combustion engine, the electrical potential at the metal shell 50 will be at the same ground level as the body of the internal combustion engine.

The ground electrode 60 is made of a metallic member extending from an end surface of the head of the metal shell 50. The ground electrode 60 is bent to have a portion (which will also be referred to as a head portion) which faces the discharge chip 31 of the center electrode 30 in the lengthwise direction of the center axis CX. The head portion of the ground electrode 60 which faces the discharge chip 31 has the discharge chip 61 secured thereto. The discharge chip 61 and the discharge chip 31 face each other through the spark gap GP in which the electrical spark is created.

The metal shell 50, as can be seen in FIG. 1, creates the annular space SP between the inner periphery of the gripping portion 52 and the outer periphery of the porcelain insulator 20. The annular space SP surrounds the center axis CX in a hollow cylindrical shape.

The annular space SP is filled with talc TC composed of talcum powder. The talc TC serves to enhance an impact resistance of the spark plug 10 and also block the leakage of gas from the internal combustion engine toward the rear end of the spark plug 10 after the spark plug 10 is installed in the internal combustion engine.

The annular space SP has disposed therein the first annular member 80 which is located at a front end (i.e., close to the center electrode 30) of the annular space SP. The annular space SP also has disposed therein the second annular member 90 which is located at a rear end (i.e., away from the center electrode 30) of the annular space SP which is opposed to the front end along the center axis CX. Each of the first and second annular members 80 and 90 is of a ring-shape surrounding the center axis CX and made from, for example, a hard metallic material, such as carbon steel. The first annular member 80 and the first annular member 90 are used to block leakage of the talc TC from the annular space SP.

In operation of the internal combustion engine, a high voltage is applied in the form of a pulse between the metal terminal 40 of the spark plug 10 and the body of the internal combustion engine. The high-voltage is then applied between the discharge chip 61 and the discharge chip 31 which face each other, thereby creating a spark discharge in the spark gap GP. The discharge chip 31 will also be referred to below as a first discharge portion. The discharge chip 61 will also be referred to below as a second discharge portion.

The generation of sparks in the spark gap GP will cause portions of the spark plug 10 where the sparks occur (i.e., the discharge chip 61 and the discharge chip 31) to be mechanically worn with time. Such wear usually arises from evaporation of a portion of the material of each of the discharge chip 61 and the discharge chip 31 which is exposed to the sparks so that it is subjected to high temperature or removal of a portion of the material which has become brittle due to long exposure to high temperature. When the discharge chip 31 is worn, it leads to a change in size of the spark gap GP, thereby resulting in instability in generating sparks. It is, therefore, necessary to increase the wear resistance of the discharge chip 31 in order to ensure the stability in operation of the spark plug 10 for a long period of time.

In order to meet the above requirement, the spark plug 10 in this embodiment is designed to have a high wear resistance derived by improving material of the discharge chip 31. The discharge chip 61 may be, however, made from the same material as in the prior art spark plugs. The material of the discharge chip 31, as discussed below, may alternatively be used as material of the discharge chip 61. In other words, at least one of the discharge chips 31 and 61 needs to be made from material which will be described below in detail. The spark plug 10 may alternatively be constructed without use of the discharge chips 31 and 61 to have the center electrode 30 and the ground electrode 60 which directly face each other through the spark gap GP. In this case, at least one of the center electrode 30 and the ground electrode 60 needs to be made from material discussed below.

The discharge chip 31 in this embodiment is made from material containing iridium (Ir), platinum (Pt), and tantalum (Ta) whose contents are regulated to be in given ranges.

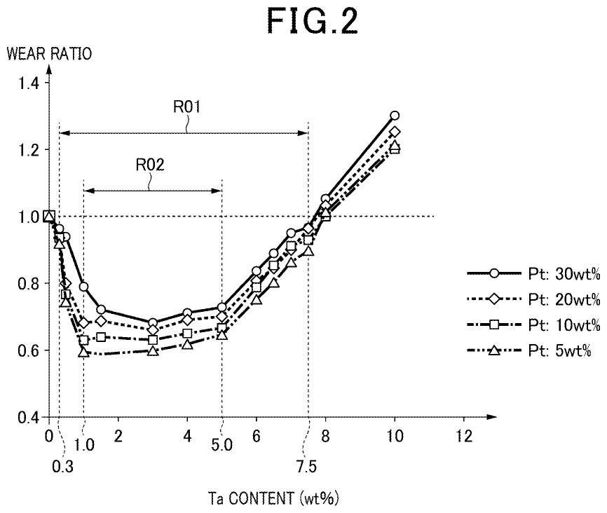

FIG. 2 represents results of wear resistance tests conducted by the inventor of this application. The wear resistance tests were made on specimens of the spark plug 10 installed in an internal combustion engine. After the internal combustion engine was driven at 5,600 rpm continuously for 50 hours, a reduction in volume of the discharge chip 31 of each specimen was measured. The internal combustion engine used was a four-cylinder engine of a total displacement of 2,000 cc.

We prepared four types of specimens of the spark plug 10. The first type of specimens are equipped with the discharge chips 31 made from material containing platinum of 30 percent by weight (Wt %) for different contents of tantalum of 0 Wt % to 10 Wt %. The second type of specimens are equipped with the discharge chips 31 made from material containing platinum of 20 Wt % for different contents of tantalum of 0 Wt % to 10 Wt %. The third type of specimens are equipped with the discharge chips 31 made from material containing platinum of 10 Wt % for different contents of tantalum of 0 Wt % to 10 Wt %. The fourth type of specimens are equipped with the discharge chips 31 made from material containing platinum of 5 Wt % for different contents of tantalum of 0 Wt % to 10 Wt %. We conducted the above-described wear resistance tests on the first to fourth types of specimens. The rest of the material of the discharge chip 31 of each specimen other than platinum and tantalum is iridium.

FIG. 2 is a graph which represents results of the wear resistance tests performed on the first to fourth types of specimens. In the graph, the abscissa axis indicates the content of tantalum (Wt %) of each of the first to fourth types of specimens. The ordinate indicates a wear ratio of the first to fourth types of specimens. The wear ratio, as referred to herein, represents a decrease in volume of each of the first to fourth types of specimens, as expressed as a ratio to 1 which is defined to denote a decrease in volume of a specimen of the spark plug 10 with the discharge chip 31 containing 0 Wt % of tantalum. The wear ratio that is less than 1 indicates that the worn volume of the discharge chip 31 is relatively decreased by the addition of tantalum to the discharge chip 31. Alternatively, the wear ratio that is more than 1 indicates that the worn volume of the discharge chip 31 is relatively increased by the addition of tantalum to the discharge chip 31.

The graph in FIG. 2 shows that the wear ratio becomes small with an increase in content of tantalum in the discharge chip 31 in a range where the content of tantalum is less than a given percent by weight (Wt %), while the wear ratio becomes great with an increase in content of tantalum in the discharge chip 31 in a range where the content of tantalum is more than the given percent by weight (Wt %) and also shows that when the content of tantalum exceeds approximately 8 Wt %, the wear ratio of each specimen is higher than 1.

In FIG. 2, the range R01 is a range where the amount of tantalum contained in the material of the discharge chip 31 is higher than or equal to 0.3 Wt % and less than or equal to 7.5 Wt %. The graph shows that when the content of tantalum lies in the range R01, it results in the wear ratio being less than 1, that is, a decrease in worn volume of the discharge chip 31.

In FIG. 2, the range R02 is a range which lies in the range R01 and where the amount of tantalum contained in the material of the discharge chip 31 is higher than or equal to 1 Wt % and less than or equal to 5 Wt %. The graph shows that when the content of tantalum lies in the range R02, it enhances the above-described beneficial effects.

Tantalum is higher in melting point than iridium and platinum which are other components of the material of the discharge chip 31. The addition of such high-melting-point tantalum to the discharge chip 31 is, therefore, thought of as a factor to reduce the removal of melted metallic components from the material of the discharge chip 31, thereby decreasing the wear of the discharge chip 31. When, however, the content of tantalum exceeds 5 Wt %, it leads to an increased risk that segregation of tantalum may occur at a grain boundary of the material of the discharge chip 31, thereby causing the material of the discharge chip 31 to become brittle. The wear ratio is, therefore, increased with an increase in content of tantalum in the discharge chip 31 which is higher than 5 Wt %. When the content of tantalum exceeds approximately 8 Wt %, the wear ratio is thought of as being higher than 1.

Platinum is known as an element to reduce the volatilization of iridium arising from oxidization thereof. The melting point of platinum is, however, lower than that of iridium. Too high a content of iridium in the discharge chip 31, therefore, results in an increased risk that the removal of material of the discharge chip 31 may be increased due to melting thereof. The inventor in this application has found that when the amount of platinum contained in the material of the discharge chip 31 is higher than 30 Wt %, the wear ratio is larger than 1 and that when the amount of platinum contained in the material of the discharge chip 31 is lower than 5 Wt %, it hardly contributes to reduce the wear ratio. It is, therefore, advisable that the amount of platinum contained in the material of the discharge chip 31 lie in a range of 5 Wt % to 30 Wt %.

In light of the above-described results of the wear resistance tests, the spark plug 10 in this embodiment is designed to have the discharge chip 31 made from material which contains iridium, platinum, and tantalum and in which the amount of platinum contained in the material lies in a range of 5 Wt % to 30 Wt %, and the amount of tantalum contained in the material lies in a range of 0.3 Wt % to 7.5 Wt % (preferably 1 Wt % to 5 Wt %), thereby enhancing the wear resistance of the discharge chip 31. Such material may be, as described above, also used to make the discharge chip 61. In summary, the improvement of the wear resistance of the spark plug 10 is, therefore, achieved by making at least one of portions of the spark plug 10 which face each other through the spark gap GP from the above-described material.

The second embodiment of the spark plug 10 will be described below. The discharge chip 31 in this embodiment is different in material from that in the first embodiment. The discharge chip 31 in this embodiment is made from material which contains iridium, platinum, tantalum, and another additive. Specifically, the material of the discharge chip 31 contains nickel (Ni) in addition to iridium, platinum, and tantalum. Instead of nickel, chromium (Cr) or cobalt (Co) may be used as an additive added to the material of the discharge chip 31. The discharge chip 31 may alternatively be made from material containing, as an additive, a mixture of two or all of nickel, cobalt, and chromium. In brief, the discharge chip 31 may be made from material with an additive of at least one of nickel, chromium, and cobalt.

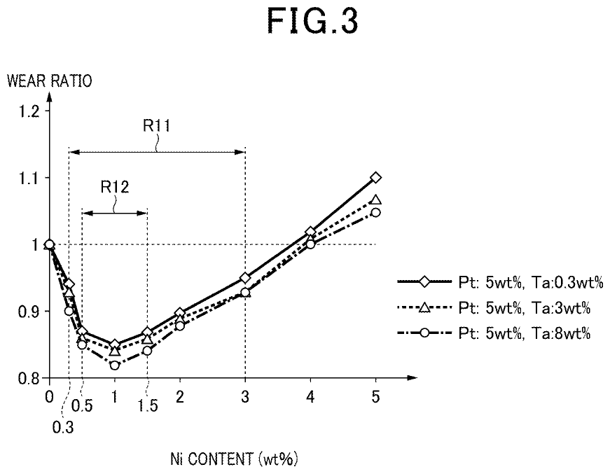

FIGS. 3, 4, and 5 are graphs which demonstrate results of the wear resistance tests performed by the inventor of this application to evaluate beneficial effects provided by addition of the above-described additive to the material of the discharge chip 35. The manner of the wear resistance tests is the same as that in the first embodiment.

We prepared three types of specimens of the spark plug 10. The first type of specimens are equipped with the discharge chips 31 made from material containing a given amount of platinum (which will be described later in detail) and tantalum of 0.3 Wt % for different contents of nickel of 0 Wt % to 5 Wt %. The second type of specimens are equipped with the discharge chips 31 made from material containing a given amount of platinum and tantalum of 3 Wt % for different contents of nickel of 0 Wt % to 5 Wt %. The third type of specimens are equipped with the discharge chips 31 made from material containing a given amount of platinum and tantalum of 8 Wt % for different contents of nickel of 0 Wt % to 5 Wt %. We conducted the above-described wear resistance tests on the first to third types of specimens. The rest of the material of the discharge chip 31 of each specimen other than platinum, tantalum, and nickel is iridium.

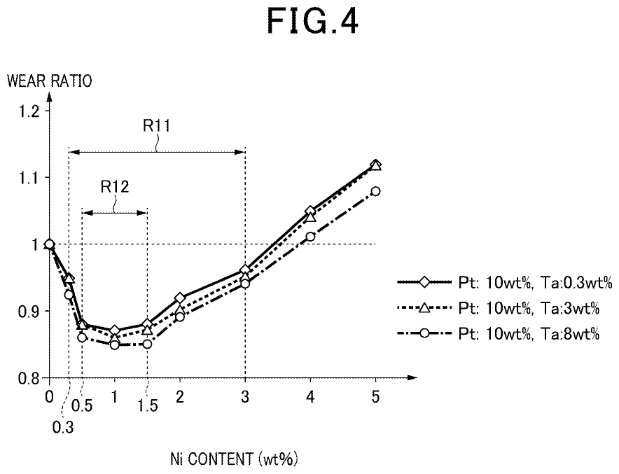

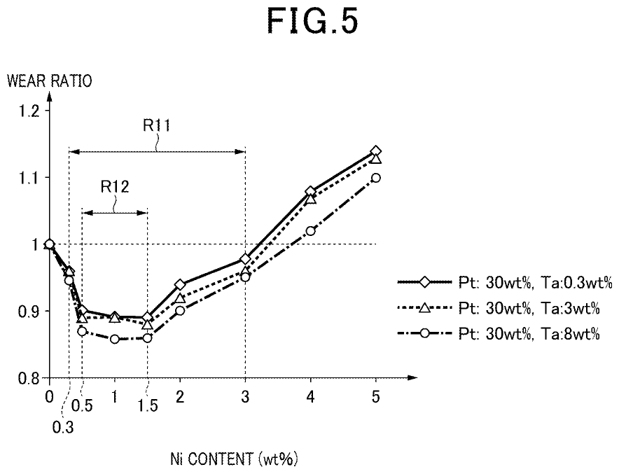

The graph in FIG. 3 represents results of the wear resistance tests on the first to third types of specimens with the discharge chips 31 containing platinum of 5 Wt % (i.e., the above-described given amount of platinum). The graph in FIG. 4 represents results of the wear resistance tests on the first to third types of specimens with the discharge chips 31 containing platinum of 10 Wt %. The graph in FIG. 5 represents results of the wear resistance tests on the first to third types of specimens with the discharge chips 31 containing platinum of 30 Wt %.

The graph in each of FIGS. 3, 4, and 5 shows that the wear ratio becomes small with an increase in additive content of nickel in the discharge chip 31 in a range where the content of nickel is less than a given percent by weight (Wt %), while the wear ratio becomes great with an increase in content of nickel in the discharge chip 31 in a range where the content of nickel is more than the given percent by weight (Wt %) and also shows that when the content of nickel exceeds approximately 4 Wt %, the wear ratio of each specimen is higher than 1.

In each of FIGS. 3, 4, and 5, the range R11 is a range where the amount of nickel contained in the material of the discharge chip 31 is higher than or equal to 0.3 Wt % and less than or equal to 3 Wt %. The graphs show that when the content of nickel lies in the range R11, it results in the wear ratio being less than 1, that is, a decrease in worn volume of the discharge chip 31.

In each of FIGS. 3, 4, and 5, the range R12 is a range which lies in the range R11 and where the amount of nickel contained in the material of the discharge chip 31 is higher than or equal to 0.5 Wt % and less than or equal to 1.5 Wt %. The graphs show that when the content of nickel lies in the range R12, it enhances the above-described beneficial effects.

FIGS. 3, 4, and 5 demonstrate examples where the material of the discharge chip 31 contains nickel as an additive, however, the inventor in this application has found that the same test results as those described above are obtained when the material of the discharge chip 31 contains chromium or cobalt as an additive or a mixture of two or all of nickel, cobalt, and chromium as an additive. In any case, the amount of the additive contained in the material of the discharge chip 31 preferably lies in the range R11 of higher than or equal to 0.3 Wt % and lower than or equal to 3 Wt %, and more preferably lines in the range R12 of higher than or equal to 0.5 Wt % and lower than or equal to 1.5 Wt %. The reason why the same beneficial effects as those described above may be obtained when the additive contained in the material of the discharge chip 31 is any one of nickel, cobalt, and chromium is because nickel, cobalt, and chromium are in the same element group.

Nickel, cobalt, and chromium are low in free energy and easier to oxidize than iridium. The addition of nickel, cobalt, and/or chromium as an additive to the material of the discharge chip 31, therefore, serves to reduce a risk that iridium may be oxidized so that it is removed from the discharge chip 31. This enhances the wear resistance of the discharge chip 31. Nickel, cobalt, and chromium are, however, lower in melting point than iridium. Consequently, when the amount of the above additive contained in the material of the discharge chip 31 is higher than 1.5 Wt %, it facilitates removal of metallic components, as melted by sparks, from the material of the discharge chip 31. When, therefore, the amount of the additive exceeds 1.5 Wt %, it leads to an increase in the wear ratio. When the amount of the additive exceeds approximately 4 Wt %, the wear ratio is thought of as being higher than 1.

The inventor in this application has found that when the above-described amount of additive is added to the material of the discharge chip 31, but the material of the discharge chip 31 contains platinum which is higher in content than 30 Wt %, the wear ratio becomes larger than 1 and that when the amount of platinum contained in the material of the discharge chip 31 is lower than 5 Wt %, it hardly contributes to reduce the wear ratio. It is, therefore, advisable that the amount of platinum contained in the material of the discharge chip 31, like in the first embodiment, lie in a range of 5 Wt % to 30 Wt %. The same is true for the content of tantalum in the material of the discharge chip 31. The content of tantalum is preferably selected to lie in the same range as in the first embodiment.

In light of the above-described results of the wear resistance tests, the spark plug 10 in the second embodiment is, like in the first embodiment, designed to have the discharge chip 31 made from material which contains iridium, platinum, and tantalum and in which the amount of platinum contained in the material lies in a range of 5 Wt % to 30 Wt %, and the amount of tantalum contained in the material lies in a range of 0.3 Wt % to 7.5 Wt % (preferably 1 Wt % to 5 Wt %), thereby enhancing the wear resistance of the discharge chip 31. The material of the discharge chip 31 in the second embodiment also contains at least one of nickel, chromium, and cobalt as an additive. The amount of the additive is selected to lie in a range of 0.3 Wt % to 3 Wt % (preferably 0.5 Wt % to 1.5 Wt %), thereby improving the wear resistance of the discharge chip 31 of the park plug 10.

The above-described material may also be, like in the first embodiment, used to make the discharge chip 61. In summary, the improvement of the wear resistance of the spark plug 10 is, therefore, achieved by making at least one of portions of the spark plug 10 which face each other through the spark gap GP from the above-described material.

The third embodiment will be described below. The discharge chip 31 in this embodiment is different in material from that in the first embodiment. The discharge chip 31 in this embodiment is, like in the second embodiment, made from material which contains iridium, platinum, tantalum, and another additive. Specifically, the material of the discharge chip 31 contains rhodium (Rh) as an additive. The additive may alternatively be ruthenium (Ru) or a mixture of rhodium and ruthenium. In other words, the discharge chip 31 is made from material containing at least one of rhodium and ruthenium as an additive.

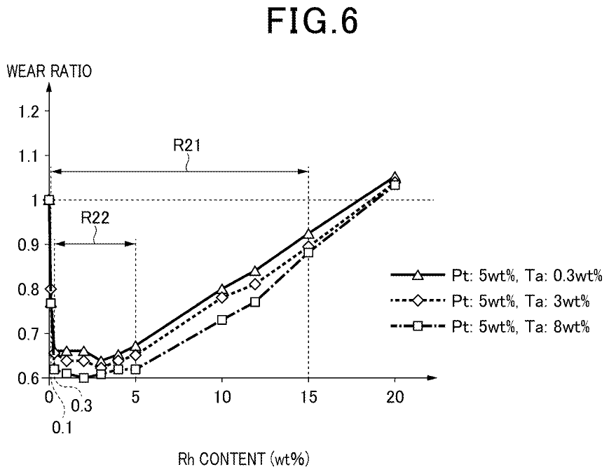

FIGS. 6, 7, and 8 are graphs which demonstrate results of the wear resistance tests performed by the inventor of this application to evaluate beneficial effects provided by addition of the above-described additive to the material of the discharge chip 35 in the third embodiment. The manner of the wear resistance tests is the same as that in the first embodiment.

We prepared three types of specimens of the spark plug 10. The first type of specimens are equipped with the discharge chips 31 made from material containing a given amount of platinum (which will be described later in detail) and tantalum of 0.3 Wt % for different contents of rhodium of 0 Wt % to 20 Wt %. The second type of specimens are equipped with the discharge chips 31 made from material containing a given amount of platinum and tantalum of 3 Wt % for different contents of rhodium of 0 Wt % to 20 Wt %. The third type of specimens are equipped with the discharge chips 31 made from material containing a given amount of platinum and tantalum of 8 Wt % for different contents of rhodium of 0 Wt % to 20 Wt %. We conducted the above-described wear resistance tests on the first to third types of specimens. The rest of the material of the discharge chip 31 of each specimen other than platinum, tantalum, and rhodium is iridium.

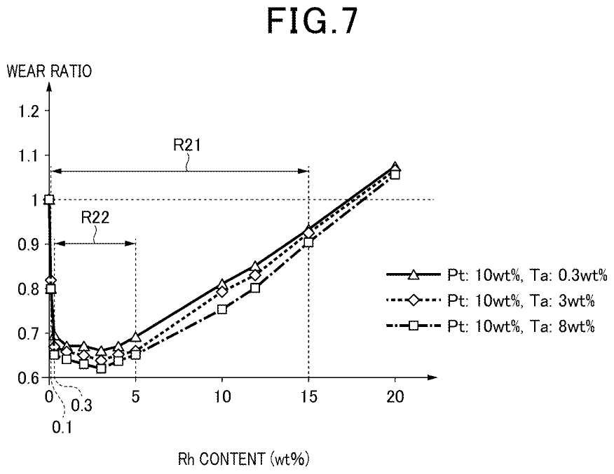

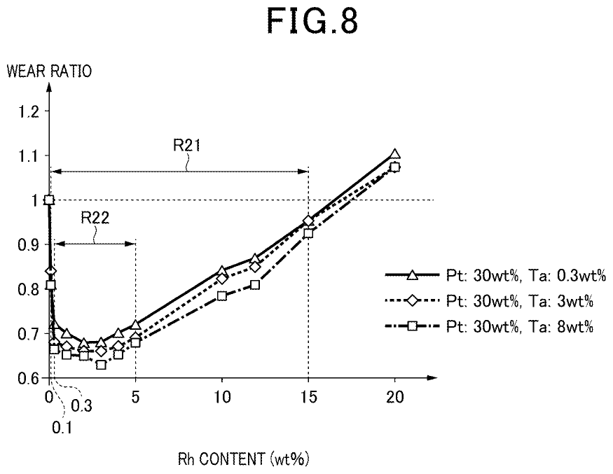

The graph in FIG. 6 represents results of the wear resistance tests on the first to third types of specimens with the discharge chips 31 containing platinum of 5 Wt % (i.e., the above-described given amount of platinum). The graph in FIG. 7 represents results of the wear resistance tests on the first to third types of specimens with the discharge chips 31 containing platinum of 10 Wt %. The graph in FIG. 8 represents results of the wear resistance tests on the first to third types of specimens with the discharge chips 31 containing platinum of 30 Wt %.

The graph in each of FIGS. 6, 7, and 8 shows that the wear ratio becomes smaller with an increase in additive content of rhodium in the discharge chip 31 in a range where the content of rhodium is less than a given percent by weight (Wt %), while the wear ratio becomes great with an increase in content of rhodium in the discharge chip 31 in a range where the content of rhodium is more than the given percent by weight (Wt %) and also shows that when the content of rhodium exceeds approximately 17 Wt %, the wear ratio of each specimen is higher than 1.

In each of FIGS. 6, 7, and 8, the range R21 is a range where the amount of rhodium contained in the material of the discharge chip 31 is higher than or equal to 0.1 Wt % and less than or equal to 15 Wt %. The graphs show that when the content of nickel lies in the range R21, it results in the wear ratio being less than 1, that is, a decrease in worn volume of the discharge chip 31.

In each of FIGS. 6, 7, and 8, the range R22 is a range which lies in the range R21 and where the amount of rhodium contained in the material of the discharge chip 31 is higher than or equal to 0.3 Wt % and less than or equal to 5 Wt %. The graphs show that when the content of rhodium lies in the range R22, it enhances the above-described beneficial effects.

FIGS. 6, 7, and 8 demonstrate examples where the material of the discharge chip 31 contains rhodium as an additive, however, the inventor in this application has found that the same test results as those described above are obtained when the material of the discharge chip 31 contains ruthenium as an additive or a mixture of rhodium and ruthenium as an additive. In any case, the amount of the additive contained in the material of the discharge chip 31 preferably lies in the range R21 of higher than or equal to 0.1 Wt % and lower than or equal to 15 Wt %, and more preferably lines in the range R22 of higher than or equal to 0.3 Wt % and lower than or equal to 5 Wt %. The reason why the same beneficial effects as those described above may be obtained when the additive contained in the material of the discharge chip 31 is rhodium or ruthenium is because rhodium and ruthenium are in the same element group.

Rhodium and ruthenium are each low in free energy and easier to oxidize than iridium. The addition of rhodium and/or ruthenium as an additive to the material of the discharge chip 31, therefore, serves to reduce a risk that iridium may be oxidized so that it is removed from the discharge chip 31. This is thought of as enhancing the wear resistance of the discharge chip 31. Rhodium and ruthenium are, however, lower in melting point than iridium. Consequently, when the amount of the above additive contained in the material of the discharge chip 31 is higher than 5 Wt %, it facilitates removal of metallic components, as melted by sparks, from the material of the discharge chip 31. When, therefore, the amount of the additive exceeds 5 Wt %, it leads to an increase in the wear ratio. When the amount of the additive exceeds approximately 17 Wt %, the wear ratio is thought of as being higher than 1.

The inventor in this application has found that when the above-described amount of additive is added to the material of the discharge chip 31, but the material of the discharge chip 31 contains platinum which is higher in content than 30 Wt %, the wear ratio becomes larger than 1 and that when the amount of platinum contained in the material of the discharge chip 31 is lower than 5 Wt %, it hardly contributes to reduce the wear ratio. It is, therefore, advisable that the amount of platinum contained in the material of the discharge chip 31, like in the first embodiment, lie in a range of 5 Wt % to 30 Wt %. The same is true for the content of tantalum in the material of the discharge chip 31. The content of tantalum has been found by the inventor to be preferably selected to lie in the same range as in the first embodiment.

In light of the above-described results of the wear resistance tests, the spark plug 10 in the third embodiment is, like in the first embodiment, designed to have the discharge chip 31 made from material which contains iridium, platinum, and tantalum and in which the amount of platinum contained in the material lies in a range of 5 Wt % to 30 Wt %, and the amount of tantalum contained in the material lies in a range of 0.3 Wt % to 7.5 Wt % (preferably 1 Wt % to 5 Wt %), thereby enhancing the wear resistance of the discharge chip 31. The material of the discharge chip 31 in the third embodiment also contains at least one of rhodium and ruthenium as an additive. The amount of the additive is selected to lie in a range of 0.1 Wt % to 15 Wt % (preferably 0.3 Wt % to 5 Wt %), thereby improving the wear resistance of the discharge chip 31 of the park plug 10.

The above-described material may also be, like in the first embodiment, used to make the discharge chip 61. In summary, the improvement of the wear resistance of the spark plug 10 is, therefore, achieved by making at least one of portions of the spark plug 10 which face each other through the spark gap GP from the above-described material.

While the preferred embodiments have been disclosed in order to facilitate better understanding of this disclosure, it should be appreciated that the disclosure can be embodied in various ways without departing from the principle of the disclosure. Therefore, the disclosure should be understood to include all possible embodiments and modifications to the shown embodiments which can be embodied without departing from the principle of the disclosure as set forth in the appended claims.

The component parts described in the above embodiments are not necessarily essential unless otherwise specified or viewed to be essential in principle. When the number of the component parts, a numerical number, a volume, or a range is referred to in the above discussion, this disclosure is not limited to it unless otherwise specified or viewed to be essential in principle. Similarly, when the shape of, the orientation of, or the positional relation among the component parts is referred to in the above discussion, this disclosure is not limited to it unless otherwise specified or viewed to be essential in principle.

1. A spark plug comprising:
a first discharge portion; and
a second discharge portion which faces the first discharge portion and works to produce a spark between itself and the first discharge portion, wherein
at least one of the first discharge portion and the second discharge portion is made from material containing iridium, platinum, and tantalum,
an amount of platinum contained in the material lies in a range of 5 Wt % to 30 Wt %, and
an amount of tantalum contained in the material lies in a range of 0.3 Wt % to 7.5 Wt %.

2. The spark plug as set forth in claim 1, wherein the amount of tantalum contained in the material lies in a range of 1 Wt % to 5 Wt %.

3. The spark plug as set forth in claim 1, wherein the material also contains an additive of at least one of nickel, chromium, and cobalt, and wherein an amount of the additive lies in a range of 0.3 Wt % to 3 Wt %.

4. The spark plug as set forth in claim 3, wherein the amount of the additive lies in a range of 0.5 Wt to 1.5 Wt %.

5. The spark plug as set forth in claim 1, wherein the material also contains an additive of at least one of rhodium and ruthenium, and wherein an amount of the additive lies in a range of 0.1 Wt % to 15 Wt %.

6. The spark plug as set forth in claim 5, wherein the amount of the additive lies in a range of 0.3 Wt to 5 Wt %.
